(19) United States
(12) Patent Application Publication
(10) Pub. No.: US 2026/0158326 A1
(43) Pub. Date: Jun. 11, 2026

(54) HINGE AND TREADMILL

(71) Applicant: Ningbo Powerful Electrical Appliance Co., Ltd., Ningbo (CN)

(72) Inventors: Chuanwen ZUO, Ningbo (CN); Xipan DONG, Ningbo (CN)

(21) Appl. No.: 19/464,890

(22) Filed: Jan. 30, 2026

(30) Foreign Application Priority Data
Nov. 25, 2025 (CN) 202522491183.8

(51) Int. Cl. A63B 22/02

(52) U.S. Cl. CPC A63B 22/02; A63B 2210/50

(57) ABSTRACT

A hinge and a treadmill are provided. The hinge includes a hinge body including: a first hinge body and a second hinge body that are opposite to each other, where an open slot is formed in the hinge body in an axial direction of the hinge body, and two ends of the open slot are respectively located on the first hinge body and the second hinge body; and a hinge assembly. One end of the hinge assembly is rotated within one end of the open slot through a hinge shaft, and another end of the hinge assembly is in sliding fit into another end of the open slot. Two side surfaces of the hinge assembly respectively abut against two inner side walls of the open slot.

### TECHNICAL FIELD

The present disclosure relates to the technical field of fitness equipment, and in particular, to a hinge and a treadmill.

### BACKGROUND

Existing treadmills have very large volumes and take up a large area of space. An insufficient indoor space at home will have an adverse impact on indoor activities. Although there are various types of foldable treadmills on the market, most of them are only folded by folding handrails and a running board or by flipping the running board to be upright. The treadmills still take up a large space and are inconvenient to store.

According to the existing technology, a hinge for a folding device No. CN223089766U is provided, including: a first folding frame, a second folding frame, and a hinge assembly. The first folding frame and the second folding frame are connected through the hinge assembly. The hinge assembly includes: a first hinge frame, a second hinge frame, a main connecting shaft, two first cranks, and two second cranks. The first hinge frame is provided with a first waist-shaped hole, and the second hinge frame is provided with a second waist-shaped hole. The first cranks and the second cranks have identical structures. The main connecting shaft penetrates through both the first cranks and the second cranks, and the first cranks and the second cranks are in rotatable contact respectively relative to the main connecting shaft. However, the first cranks and the second cranks are of sheet-like structures having low strength and are prone to deformation. Furthermore, a large gap exists between the first cranks and the second cranks, so that looseness easily occurs and the rotation is unstable.

### SUMMARY

The technical problems to be solved in the present disclosure are to overcome the defects in the existing technology and provide a hinge and a treadmill that have high intensity and stable rotation.

To achieve the above objectives, a technical solution of the present disclosure is as follows: a hinge, including a hinge body. The hinge body includes:
a first hinge body and a second hinge body that are opposite to each other, where an open slot is formed in the hinge body in an axial direction of the hinge body; two ends of the open slot are respectively located on the first hinge body and the second hinge body; and
a hinge assembly, where one end of the hinge assembly is rotated within one end of the open slot through a hinge shaft, and another end of the hinge assembly is in sliding fit into another end of the open slot; two side surfaces of the hinge assembly respectively abut against two inner side walls of the open slot;
under an action of the hinge assembly, the first hinge body is rotated relative to the second hinge body; and the two side surfaces of the hinge assembly are respectively in sliding fit onto the two inner side walls of the open slot.

By the adoption of the above structure, compared with the existing technology, the present disclosure has the following advantages: The hinge body includes: the first hinge body and the second hinge body that are opposite to each other. The first hinge body and the second hinge body are hinged to each other through the hinge assembly. Specifically, the open slot is provided, and the two ends of the open slot are respectively located on the first hinge body and the second hinge body. One end of the hinge assembly is hinged into one end of the open slot, and another end of the hinge assembly is in sliding fit into another end of the open slot. The two side surfaces of the hinge assembly respectively abut against the two inner side walls of the open slot. A width of the hinge assembly is equal to a width of the open slot. In this way, the intensity of the hinge assembly is higher than that of a sheet-like structure, and the two side surfaces of the hinge assembly are respectively in sliding fit with the two inner side walls of the open slot, thus achieving a guiding effect and making rotation more stable.

Preferably, a hinge groove that penetrates through the hinge body is formed in a bottom of the open slot corresponding to a position at which the first hinge body and the second hinge body are connected to each other; and one end of the hinge assembly is hinged into the hinge groove. It is convenient for the hinge assembly to achieve hinging between the first hinge body and the second hinge body.

Preferably, the hinge assembly includes at least one hinge member; hinge members are parallel to each other, and two adjacent hinge members abut against each other; and one end of each hinge member is hinged into one end of the open slot, and another end of the hinge member is in sliding fit into another end of the open slot. Thus, the entire hinge assembly has high intensity.

Preferably, the two adjacent hinge members are respectively hinged onto the first hinge body and the second hinge body; and when the first hinge body is rotated relative to the second hinge body, the two adjacent hinge members are in relatively sliding fit with each other. It is convenient for mutual guidance between the two adjacent hinge members, and the rotation is more stable.

Preferably, the two adjacent hinge members are linked with each other, which is convenient to drive the hinge members to rotate more easily.

Preferably, the hinge further includes a linkage member parallel to the hinge shaft; two ends of the linkage member are respectively in rotational fit into middle portions of the two adjacent hinge members; and
when the first hinge body is rotated relative to the second hinge body, rotation of a hinge member drives an adjacent hinge member to rotate through the linkage member. The structure is simple.

Preferably, two hinge members are provided; cross sections of the hinge members are “L”-shaped; a wider end of each hinge member is in sliding fit into the open slot; and a narrower end of the hinge member is hinged into the open slot. This can ensure that the two adjacent hinge members abut against each other and can cause the hinge members to be in sliding fit with the two inner side walls of the open slot.

Preferably, the open slot has a first end and a second end in a radial direction; and a depth of the first end of the open slot is greater than a depth of the second end of the open slot. A step is formed at a bottom of the open slot. In this way, when the hinge assembly is in the axial direction of the open slot, the step plays a role in guiding.

Preferably, at least one inner side wall of the open slot is provided with a guide slot in an axial direction of the open slot, and a guide rod corresponding to the guide slot is arranged on a side surface of the hinge assembly; and
when the first hinge body is rotated relative to the second hinge bod, the guide rod is in sliding fit into the guide slot to guide the hinge assembly, so that the reliability is high.

A treadmill includes any one of the above hinges.

### BRIEF DESCRIPTION OF THE DRAWINGS

FIG. 1 is a three-dimensional diagram of a hinge in one angle according to the present disclosure.

FIG. 2 is a three-dimensional diagram of a hinge in another angle according to the present disclosure.

FIG. 3 is a three-dimensional diagram of a first hinge body and a second hinge body of a hinge according to the present disclosure.

FIG. 4 is a three-dimensional diagram of a hinge assembly of a hinge according to the present disclosure.

FIG. 5 is a three-dimensional diagram of a hinge member of a hinge according to the present disclosure.

FIG. 6 is front cross-sectional view of a first embodiment of use of a hinge to a treadmill according to the present disclosure.

FIG. 7 is front cross-sectional view of a second embodiment of use of a hinge to a treadmill according to the present disclosure.

1: hinge body; 110: open slot; 111: hinge groove; 112: guide slot; 113: step; 120:
fixing through hole; 2: first hinge body; 3: second hinge body; 4: hinge assembly; 410: hinge member; 411: rotating slot; 420: guide rod; 5: hinge shaft; 6: linkage member; 7: first folding frame; and 8: second folding frame.

### DETAILED DESCRIPTION OF THE EMBODIMENTS

The present disclosure will be further explained below in conjunction with the accompanying drawings and specific implementations.

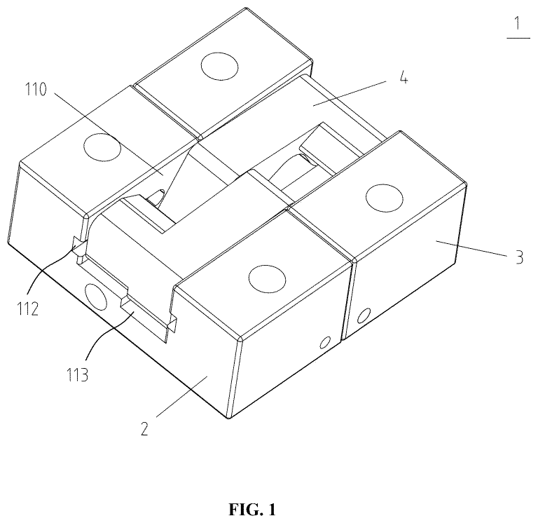

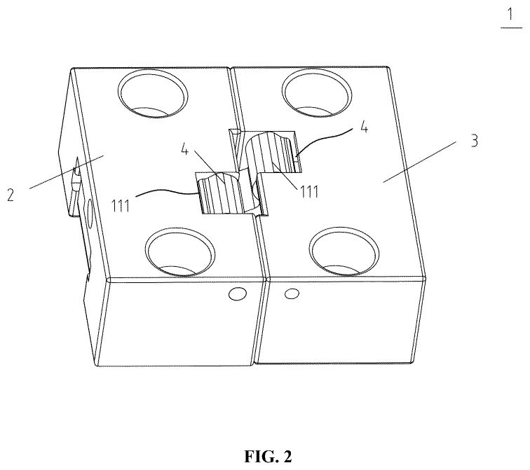

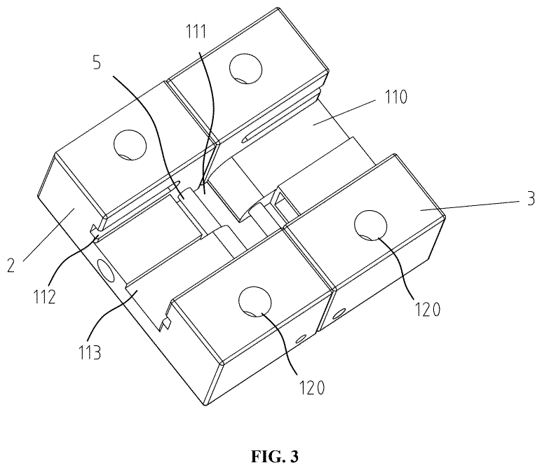

FIG. 1 is a three-dimensional diagram of a hinge in one angle according to the present disclosure. FIG. 2 is a three-dimensional diagram of a hinge in another angle according to the present disclosure. FIG. 3 is a three-dimensional diagram of a first hinge body and a second hinge body of a hinge according to the present disclosure. In the embodiments shown in FIG. 1, FIG. 2, and FIG. 3, the present disclosure provides a hinge, including a hinge body 1. The hinge body 1 includes a first hinge body 2, a second hinge body 3, and a hinge assembly 4. The first hinge body 2 and the second hinge body 3 are hinged to each other through the hinge assembly 4. The rotation of the first hinge body 2 or the rotation of the second hinge body 3 causes the first hinge body 2 and the second hinge body 3 to be folded together or unfolded. Specifically, to enhance the intensity of the hinge assembly 4 and the stability of rotation, an open slot 110 is formed in a surface of the hinge body 1 in an axial direction of the hinge body 1. Two ends of the open slot 110 are respectively located on the first hinge body 2 and the second hinge body 3. That is, one part of the open slot 110 is located on the first hinge body 2, and the other part of the open slot 110 is located on the second hinge body 3. One end of the hinge assembly 4 is hinged into one end of the open slot 110 through a hinge shaft 5, and another end of the hinge assembly 4 is in sliding fit into another end of the open slot 110. That is, one end of the hinge assembly 4 is hinged onto the first hinge body 2 or the second hinge body 3, and another end of the hinge assembly 4 is in sliding fit onto the second hinge body 3 or the first hinge body 2. In this way, when one of the first hinge body 2 and the second hinge body 3 is rotated, the hinge assembly 4 is in sliding fit into the other one, and the other one can remain stationary. This facilitates folding or unfolding between the first hinge body 2 and the second hinge body 3. Two sides of the hinge assembly 4 respectively abut against two inner side walls of the open slot 110. That is, a width of the hinge assembly 4 is equal to a width of the open slot 110. The hinge assembly 4 is of a block-shaped structure. In this way, the intensity of the hinge assembly 4 is greater than that of a sheet-like structure. The two side surfaces of the hinge assembly 4 are respectively in sliding fit onto the two inner side walls of the open slot 110, thus playing a role in guiding and making rotation more stable.

One end of the hinge assembly 4 is hinged onto the first hinge body 2 or the second hinge body 3, and another end of the hinge assembly 4 is in sliding fit onto the second hinge body 3 or the first hinge body 2. That is, one end of the hinge assembly 4 is hinged onto the first hinge body 2, and another end of the hinge assembly 4 is in sliding fit onto the second hinge body 3. Alternatively, one end of the hinge assembly 4 is hinged onto the second hinge body 3, and another end of the hinge assembly 4 is in sliding fit onto the first hinge body 2.

One part of the open slot 110 is located on the first hinge body 2, and the other part of the open slot 110 is located on the second hinge body 3. Specifically, half of the open slot 110 is located on the first hinge body 2, and the other half of the open slot 110 is located on the second hinge body 3. This facilitates the arrangement. Specifically, two ends of the open slot 110 respectively penetrate through an outer side surface of the first hinge body 2 and an outer side surface of the second hinge body 3 in the axial direction of the hinge body 1. The hinge assembly 4 can be mounted inside the open slot 110 from the outer side surface of the first hinge body 2 and the outer side surface of the second hinge body 3. It is convenient to mount the hinge assembly 4.

In one embodiment, a hinge groove 111 that penetrates through the hinge body 1 is formed in a bottom of the open slot 110 corresponding to a position at which the first hinge body 2 and the second hinge body 3 are connected to each other; and one end of the hinge assembly 4 is hinged into the hinge groove 111 through the hinge shaft 5. It is convenient for the hinge assembly 4 to achieve hinging between the first hinge body 2 and the second hinge body 3. Specifically, the hinge groove 111 is located on a side surface of the first hinge body 2 facing the second hinge body 3 and a side surface of the second hinge body 3 facing the first hinge body 2, respectively. The hinge groove 111 communicates the open slot 110 with the outside of the hinge body 1.

In one embodiment, the open slot 110 has a first end and a second end in a radial direction. A depth of the first end of the open slot 110 is greater than a depth of the second end of the open slot 110. A step 113 is formed at a bottom of the open slot 110. In this way, when the hinge assembly 4 is in the axial direction of the open slot 110, the step 113 plays a role in guiding. The first hinge body 2 and the second hinge body 3 are more stable during rotation.

In one embodiment, at least one inner side wall of the open slot 110 is provided with a guide slot 112 in the axial direction of the open slot 110. A guide rod 420 corresponding to the guide slot 112 is arranged on a side surface of the hinge assembly 4. When the first hinge body 2 is rotated relative to the second hinge body 3, the guide rod 420 is in sliding fit into the guide slot 112, which can prevent the hinge assembly 4 from being detached from the open slot 110 and guide the hinge assembly 4, with high reliability. Specifically, the two inner side walls of the open slot 110 are provided with guide slots 112. The two outer side surfaces of the hinge assembly 4 are provided with guide rods 420. The guide effect is better.

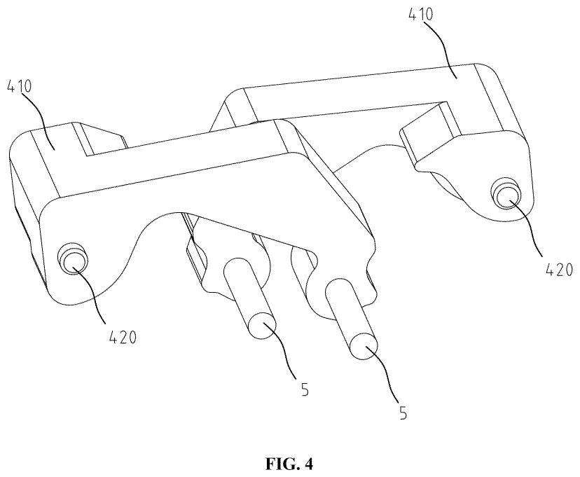

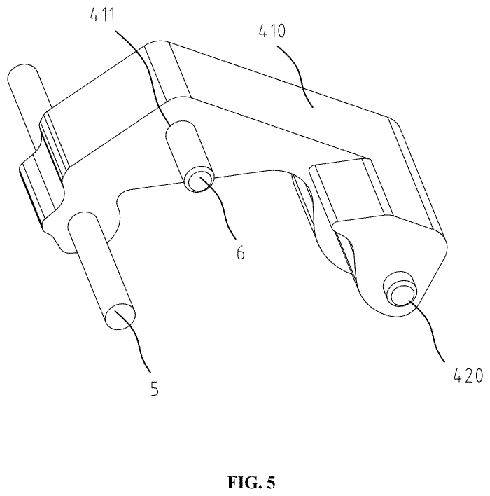

FIG. 4 is a three-dimensional diagram of a hinge assembly of a hinge according to the present disclosure. FIG. 5 is a three-dimensional diagram of a hinge member of a hinge according to the present disclosure. In the embodiments shown in FIG. 4 and FIG. 5, the hinge assembly 4 includes at least one hinge member 410. Hinge members 410 are parallel to each other, and two adjacent hinge members 410 abut against each other. One end of each hinge member 410 is hinged into one end of the open slot 110, and another end of the hinge member 410 is in sliding fit into another end of the open slot 110. The two adjacent hinge members 410 abut against each other, so that the intensity of the entire hinge assembly 4 is high. Specifically, one or more hinge members 410 are provided.

In one embodiment, the two adjacent hinge members 410 are respectively hinged onto the first hinge body 2 and the second hinge body 3. When the first hinge body 2 is rotated relative to the second hinge body 3, the two adjacent hinge members 410 are in relatively sliding fit with each other. It is convenient for mutual guidance between the two adjacent hinge members 410, and the rotation is more stable. Further, the two adjacent hinge members 410 are linked with each other. This can drive the hinge members 410 to move in sequence. It is convenient to drive the hinge members 410 to rotate more easily. Still further, the hinge further includes a linkage member 6 parallel to the hinge shaft 5. Two ends of the linkage member 6 are respectively in rotational fit into middle portions of the two adjacent hinge members 410. When the first hinge body 2 is rotated relative to the second hinge body 3, rotation of a hinge member 410 drives an adjacent hinge member 410 to rotate through the linkage member 6. The structure is simple. Specifically, rotating slots 411 are formed in opposite side surfaces of the two adjacent hinge members 410. Two ends of the linkage member 6 are respectively in rotational fit into the rotating slots 411.

In one embodiment, two hinge members 410 are provided. Cross sections of the hinge members 410 are “L”-shaped. A wider end of each hinge member 410 is in sliding fit into the open slot 110, and a narrower end of the hinge member 410 is hinged into the open slot 110. This can ensure that the two adjacent hinge members 410 abut against each other and can cause the hinge members 410 to be in sliding fit with the two inner side walls of the open slot 110. Two side surfaces of the wider end of the hinge member 410 are respectively in sliding fit with the two inner side surfaces of the open slot 110. One side surface of the narrower end of the hinge member 410 abuts against an inner side wall of the open slot 110. Another side surface of the narrower end of the hinge member 410 abuts against the side surface of the adjacent hinge member 410. The two adjacent hinge members 410 slide relative to each other through abutment, so that the two side surfaces of the hinge members 410 can achieve guidance to ensure that the relative rotation between the first hinge body 2 and the second hinge body 3 is more stable. Specifically, the width refers to a dimension in the radial direction of the open slot 110.

Specifically, a longitudinal section of the hinge member 410 is crank-shaped. In this embodiment, a cross section is a projection on a horizontal plane, and a longitudinal section is a projection on a vertical plane.

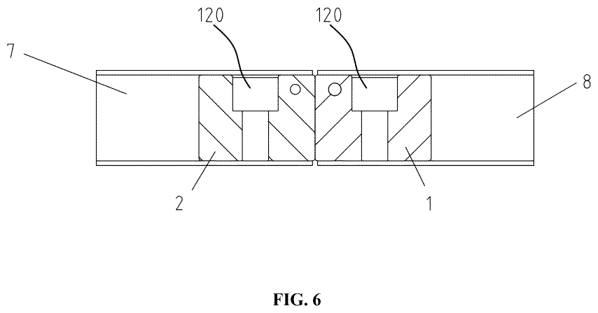

FIG. 6 is front cross-sectional view of a first embodiment of use of a hinge to a treadmill according to the present disclosure. In the embodiment shown in FIG. 6, the present disclosure provides a treadmill including any one of the hinges described above, and further including a first folding frame 7 and a second folding frame 8. The first folding frame 7 and the second folding frame 8 are of square tube structures, and the first hinge body 2 and the second hinge body 3 are respectively mounted inside the first folding frame 7 and the second folding frame 8. By respectively mounting the first hinge body 2 and the second hinge body 3 inside the first folding frame 7 and the second folding frame 8, hinging between the first folding frame 7 and the second folding frame 8 is achieved, thereby achieving folding. Specifically, both the first hinge body 2 and the second hinge body 3 are provided with fixing through holes 120, and a bolt is sequentially threaded through an upper end of the first folding frame 7 and the fixing through hole 120 to be screwed into a lower end of the first folding frame 7. A bolt is sequentially threaded through an upper end of the second folding frame 8 and the fixing through hole 120 to be screwed into a lower end of the second folding frame 8.

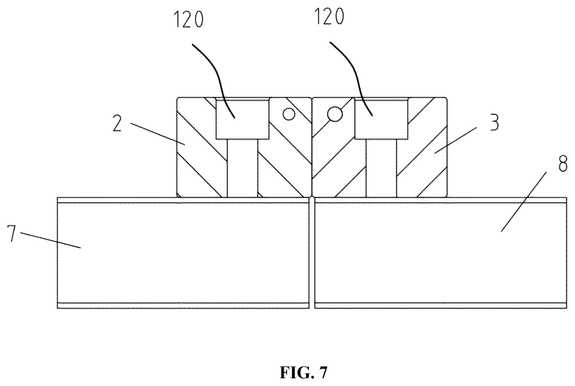

FIG. 7 is front cross-sectional view of a second embodiment of use of a hinge to a treadmill according to the present disclosure. In the embodiment shown in FIG. 7, the present disclosure provides a treadmill including any one of the hinges described above, and further including a first folding frame 7 and a second folding frame 8. The first hinge body 2 and the second hinge body 3 are respectively mounted on an upper surface of the first folding frame 7 and an upper surface of the second folding frame 8. By respectively mounting the first hinge body 2 and the second hinge body 3 on the first folding frame 7 and the second folding frame 8, hinging between the first folding frame 7 and the second folding frame 8 is achieved, thereby achieving folding. Specifically, both the first hinge body 2 and the second hinge body 3 are provided with fixing through holes 120. A bolt is screwed onto the first folding frame 7 through the fixing through hole 120, and a bolt is screwed onto the second folding frame 8 through the fixing through hole 120.

Specifically, during the mounting of the hinge body 1, the hinge groove 111 is oriented towards a folding direction. As in this embodiment, both the first folding frame 7 and the second folding frame 8 are folded upwards, so the hinge groove 111 is mounted upwards.

The principle of the present disclosure is as follows: The hinge body 1 includes: the first hinge body 2 and the second hinge body 3 that are opposite to each other. The first hinge body 2 and the second hinge body 3 are hinged to each other through the hinge assembly 4. Specifically, the open slot 110 is provided, and the two ends of the open slot 110 are respectively located on the first hinge body 2 and the second hinge body 3. One end of the hinge assembly 4 is hinged into one end of the open slot 110, and another end of the hinge assembly 4 is in sliding fit into another end of the open slot 110. The two side surfaces of the hinge assembly 4 respectively abut against the two inner side walls of the open slot 110. A width of the hinge assembly 4 is equal to a width of the open slot 110. In this way, the intensity of the hinge assembly 4 is higher than that of a sheet-like structure, and the two side surfaces of the hinge assembly 4 are respectively in sliding fit with the two inner side walls of the open slot 110, thus achieving a guiding effect and making rotation more stable.

Action process: One hinge member 410 is provided: When one end of the hinge member 410 is hinged onto the first hinge body 2, the first hinge body 2 is rotated upwards and is folded towards the second hinge body 3. In this case, another end of the hinge member 410 is in sliding fit onto the second hinge body 3. When one end of the hinge member 410 is hinged onto the second hinge body 3, the second hinge body 3 is rotated upwards and is folded towards the first hinge body 1. In this case, another end of the hinge member 410 is in sliding fit onto the first hinge body 2.

Two hinge members 410 are provided. One end of one hinge member 410 is hinged to the first hinge body 2, and one end of the other hinge member 410 is hinged to the second hinge body 3. This allows the first hinge body 2 or the second hinge body 3 to be freely rotated upwards to achieve mutual folding between the first hinge body 2 and the second hinge body 3.

Based on the solutions, if various modifications or transformations to the present disclosure do not deviate from the spirit and scope of the present disclosure, and if these modifications and transformations fall within the claims and equivalent technical scopes of the present disclosure, the present disclosure also intends to encompass these modifications and transformations.

What is claimed is:

1. A hinge, comprising a hinge body (1), wherein the hinge body (1) comprises:
a first hinge body (2) and a second hinge body (3) that are opposite to each other, wherein an open slot (110) is formed in the hinge body (1) in an axial direction of the hinge body (1); two ends of the open slot (110) are respectively located on the first hinge body (2) and the second hinge body (3); and
a hinge assembly (4), wherein one end of the hinge assembly (4) is rotated within one end of the open slot (110) through a hinge shaft (5), and another end of the hinge assembly (4) is in sliding fit into another end of the open slot (110); two side surfaces of the hinge assembly (4) respectively abut against two inner side walls of the open slot (110);
under an action of the hinge assembly (4), the first hinge body (2) is rotated relative to the second hinge body (3); and the two side surfaces of the hinge assembly (4) are respectively in sliding fit onto the two inner side walls of the open slot (110).

2. The hinge according to claim 1, wherein a hinge groove (111) that penetrates through the hinge body (1) is formed in a bottom of the open slot (110) corresponding to a position at which the first hinge body (2) and the second hinge body (3) are connected to each other; and
one end of the hinge assembly (4) is hinged into the hinge groove (111).

3. The hinge according to claim 1, wherein
the hinge assembly (4) comprises at least one hinge member (410); hinge members (410) are parallel to each other, and two adjacent hinge members (410) abut against each other; and one end of each hinge member (410) is hinged into one end of the open slot (110), and another end of the hinge member (410) is in sliding fit into another end of the open slot (110).

4. The hinge according to claim 3, wherein the two adjacent hinge members (410) are respectively hinged onto the first hinge body (2) and the second hinge body (3); and when the first hinge body (2) is rotated relative to the second hinge body (3), the two adjacent hinge members (410) are in relatively sliding fit with each other.

5. The hinge according to claim 4, wherein the two adjacent hinge members (410) are linked with each other.

6. The hinge according to claim 5,
further comprising a linkage member (6) parallel to the hinge shaft (5), wherein two ends of the linkage member (6) are respectively in rotational fit into middle portions of the two adjacent hinge members (410); and
when the first hinge body (2) is rotated relative to the second hinge body (3), rotation of a hinge member (410) drives an adjacent hinge member (410) to rotate through the linkage member (6).

7. The hinge according to claim 3, wherein two hinge members (410) are provided; cross sections of the hinge members (410) are “L”-shaped; a wider end of each hinge member (410) is in sliding fit into the open slot (110); and a narrower end of the hinge member (410) is hinged into the open slot (110).

8. The hinge according to claim 1, wherein the open slot (110) has a first end and a second end in a radial direction; and a depth of the first end of the open slot (110) is greater than a depth of the second end of the open slot (110).

9. The hinge according to claim 1, wherein
at least one inner side wall of the open slot (110) is provided with a guide slot (112) in an axial direction of the open slot (110), and a guide rod (420) corresponding to the guide slot (112) is arranged on a side surface of the hinge assembly (4); and
when the first hinge body (2) is rotated relative to the second hinge body (3), the guide rod (420) is in sliding fit into the guide slot (112).

10. A treadmill, comprising the hinge according to claim 1.
